(19) United States
(12) Patent Application Publication
(10) Pub. No.: US 2025/0149744 A1
(43) Pub. Date: May 8, 2025

(54) ASSEMBLED-BATTERY STRUCTURE AND COMPOSITE ASSEMBLED-BATTERY STRUCTURE

(71) Applicant: TOYOTA JIDOSHA KABUSHIKI KAISHA, Toyota-shi (JP)

(72) Inventor: Sadao FUJISAKI, Toyota-shi (JP)

(73) Assignee: TOYOTA JIDOSHA KABUSHIKI KAISHA, Toyota-shi (JP)

(21) Appl. No.: 18/882,965

(22) Filed: Sep. 12, 2024

(30) Foreign Application Priority Data
Nov. 6, 2023 (JP) 2023-189151

(51) Int. Cl. H01M 50/503; H01M 50/211; H01M 50/298; H01M 50/526

(52) U.S. Cl. CPC H01M 50/503; H01M 50/211; H01M 50/298; H01M 50/526

(57) ABSTRACT

An assembled-battery structure includes: a plurality of batteries; and a connection member connected to the plurality of batteries, in which: each battery includes a first terminal disposed on one surface in a thickness direction, a second terminal disposed on the other surface, and a plurality of connection terminals disposed on an identical surface to the surface on which the first terminal is disposed; the connection member includes a first-terminal connection portion, a second-terminal connection portion, and a connection-terminal connection portion; the first-terminal connection portion includes a first metal layer electrically connected to the first terminals of the batteries; the second-terminal connection portion includes a second metal layer electrically connected to the second terminals of the batteries; the connection-terminal connection portion includes a plurality of terminals electrically connected to the connection terminals of the batteries; and the first-terminal connection portion and the connection-terminal connection portion are disposed on an identical surface.

### CROSS-REFERENCE TO RELATED APPLICATION

This application claims priority to Japanese Patent Application No. 2023-189151 filed on Nov. 6, 2023, incorporated herein by reference in its entirety.

### BACKGROUND

### 1. Technical Field

The present application relates to an assembled-battery structure and a composite assembled-battery structure.

### 2. Description of Related Art

Japanese Unexamined Patent Application Publication No. 2006-127857 (JP 2006-127857 A) discloses a bipolar battery in which a connection terminal is drawn out from a side surface portion.

### SUMMARY

However, since the connection terminal is drawn out from the side surface portion, there is a problem in that a member that is connected to the connection terminal needs to be disposed at the side surface portion and therefore the total size of the battery becomes large.

In view of the above circumstance, a main object of the present disclosure is to provide an assembled-battery structure that makes it possible to enhance structural efficiency. Further, another object of the present disclosure is to provide a composite assembled-battery structure in which the above assembled-battery structure is used.

The present disclosure provides at least the following aspects.

A first aspect is an assembled-battery structure including: a plurality of batteries; and a connection member connected to the plurality of batteries, in which: each of the batteries includes a first terminal disposed on one surface in a thickness direction, a second terminal disposed on the other surface in the thickness direction, and a plurality of connection terminals disposed on an identical surface to the surface on which the first terminal is disposed; the connection member includes a first-terminal connection portion, a second-terminal connection portion, and a connection-terminal connection portion; the first-terminal connection portion includes a first metal layer, and the first metal layer is electrically connected to the first terminals of the batteries; the second-terminal connection portion includes a second metal layer, and the second metal layer is electrically connected to the second terminals of the batteries; the connection-terminal connection portion includes a plurality of terminals, and the terminals are electrically connected to the connection terminals of the batteries; and the first-terminal connection portion and the connection-terminal connection portion are disposed on an identical surface.

A second aspect is the assembled-battery structure according to the first aspect, in which: the connection-terminal connection portion includes a base plate that supports the plurality of terminals; the base plate includes a plurality of terminal wires; and each of the terminal wires is electrically connected to at least one of the terminals.

A third aspect is the assembled-battery structure according to the first or the second aspect, in which: the plurality of terminals is divided for each of the batteries; and corresponding terminals of terminal groups are connected to one of the terminal wires in parallel, each of the terminal groups being a group of the divided terminals.

A fourth aspect is the assembled-battery structure according to any one of the first to third aspects, in which the first-terminal connection portion and the connection-terminal connection portion are integrated.

A fifth aspect is the assembled-battery structure according to any one of the first to fourth aspects, in which the first-terminal connection portion, the second-terminal connection portion, and the connection-terminal connection portion have flexibility.

A sixth aspect is a composite assembled-battery structure including: a plurality of the assembled-battery structures according to any one of the first to fifth aspects; and a joining member that joins the plurality of the assembled-battery structures, in which the joining member includes a plurality of joining terminals, and the joining terminals are electrically connected to terminal wires of the assembled-battery structures.

With the assembled-battery structure and the composite assembled-battery structure in the present disclosure, it is possible to enhance structural efficiency.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view of an assembled-battery structure 1000;

FIG. 2 is a sectional view of the assembled-battery structure 1000 taken from II-II in FIG. 1;

FIG. 3 is a plan view of a battery 100;

FIG. 4A is a sectional view of the battery 100 taken from IV-IV in FIG. 3;

FIG. 4B is an exploded sectional view of the battery 100;

FIG. 5 is a plan view of an electrode laminated body 50;

FIG. 6A is an elevational view of the electrode laminated body 50 as viewed from an A-direction in FIG. 5;

FIG. 6B is a side view of the electrode laminated body 50 as viewed from a B-direction in FIG. 5;

FIG. 7A is a plan view of an internal current collector 20;

FIG. 7B is a plan view of a plurality of internal current collectors 20 for describing differences in the position and length of a connection portion 22;

FIG. 8 is a sectional view of an electrode laminated body 50 that is an example;

FIG. 9 is a partial sectional view focusing on one connection terminal 70;

FIG. 10 is a diagram showing an example of a method for providing the connection terminal 70 on an outer packaging body 90;

FIG. 11 is a bottom view of a positive-electrode-terminal connection portion 200 and a connection-terminal connection portion 400;

FIG. 12 is a plan view of a negative-electrode-terminal connection portion 300;

FIG. 13A is a sectional view focusing on a terminal group 410, and is a diagram showing a section on which a terminal 411a and a terminal wire 412a are connected;

FIG. 13B is a sectional view focusing on the terminal group 410, and is a diagram showing a section on which a terminal 411b and a terminal wire 412b are connected;

FIG. 14 is a diagram showing the form of an assembled-battery structure in which batteries 100 are laminated in a zigzag manner;

FIG. 15 is a bottom view of a positive-electrode-terminal connection portion 1200 and a connection-terminal connection portion 1400 in a different mode;

FIG. 16 is a plan view of a negative-electrode-terminal connection portion 1300 in the different mode;

FIG. 17 is a plan view of a composite assembled-battery structure 2000; and

FIG. 18 is a plan view of a joining member 1100.

### DETAILED DESCRIPTION OF EMBODIMENTS

### Assembled-Battery Structure

An assembled-battery structure in the present disclosure will be described with use of an assembled-battery structure 1000 that is an embodiment.

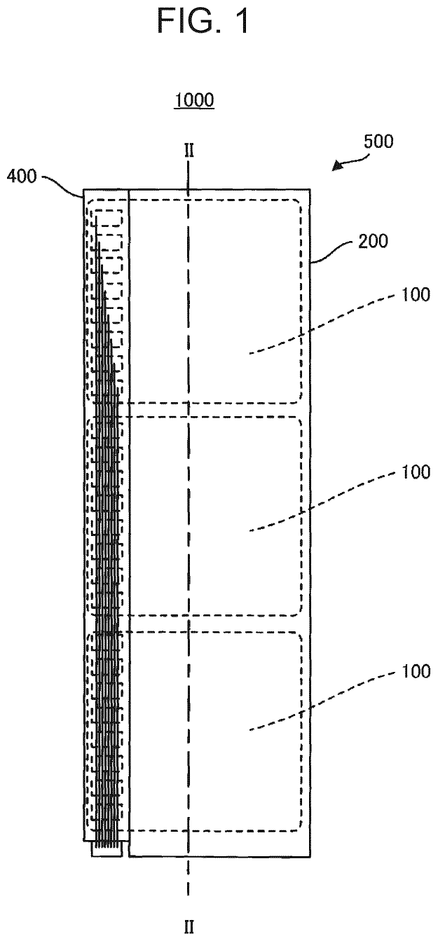

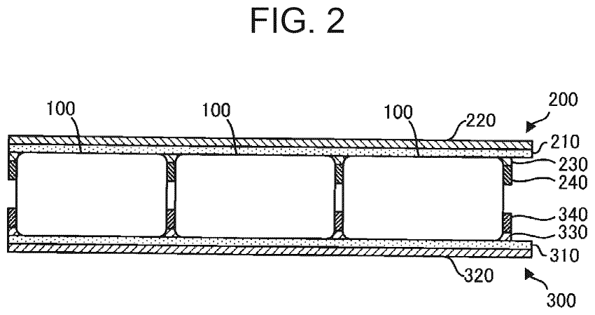

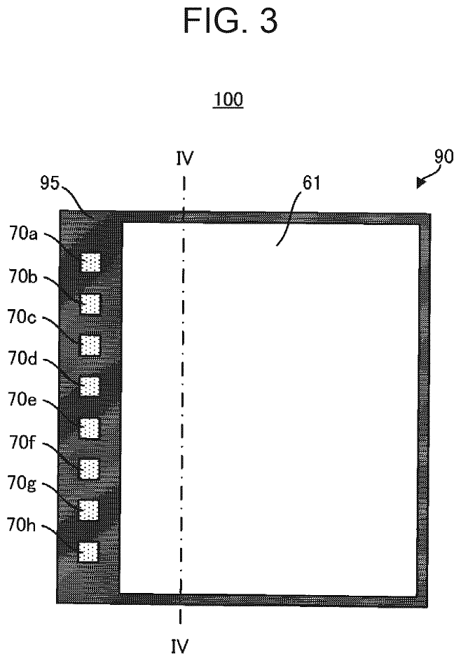

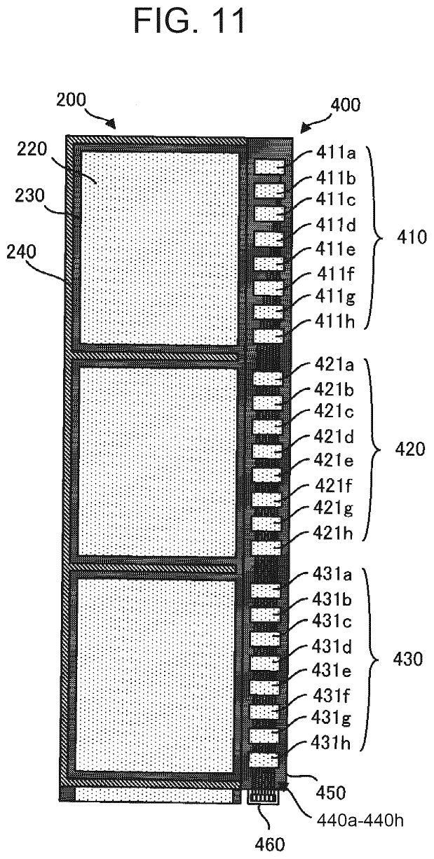

The assembled-battery structure 1000 includes a plurality of batteries 100 and a connection member 500 connected to the plurality of batteries 100. FIG. 1 shows a plan view of the assembled-battery structure 1000. FIG. 2 shows a sectional view taken from II-II in FIG. 1. In FIG. 1, terminals 411a to 411h, 421a to 421h, 431a to 431h (see FIG. 11) and batteries 100 (see FIG. 3) disposed inside the assembled-battery structure 1000 are shown by dotted lines.

### Battery 100

First, the battery 100 will be described. The battery 100 includes a first terminal disposed on one surface in a thickness direction, a second terminal disposed on the other surface in the thickness direction, and a plurality of connection terminals disposed on the identical surface to the surface on which the first terminal is disposed. A mode in which the first terminal is used as a positive electrode terminal 61 and the second terminal is used as a negative electrode terminal 62 will be described later. However, the first terminal may be a negative electrode terminal, and the second terminal may be a positive electrode terminal. The first terminal and the second terminal are set so as to be heteropolar electrodes.

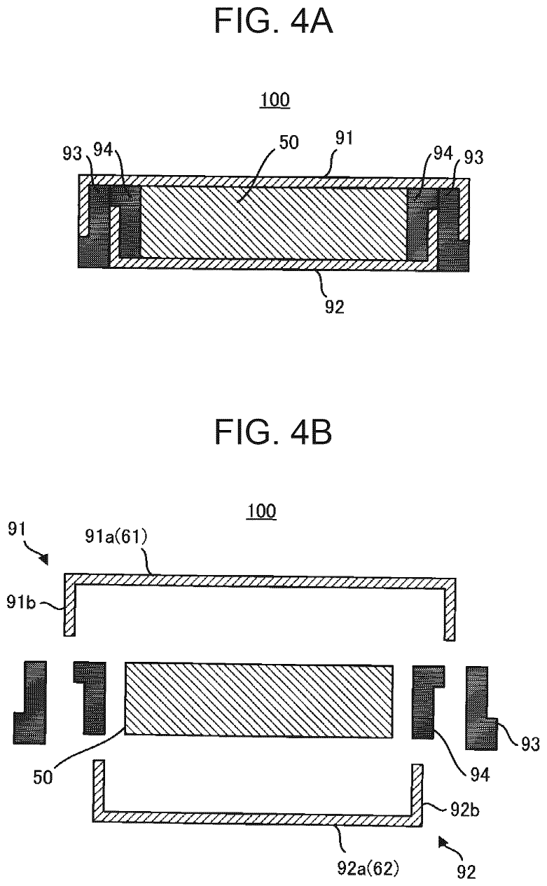

FIG. 3 shows a plan view of the battery 100. FIG. 4A shows a sectional view of the battery 100 taken from IV-IV in FIG. 3, and FIG. 4B shows an exploded sectional view of the battery 100. As shown in FIG. 3, FIG. 4A, and FIG. 4B, the battery 100 includes an electrode laminated body 50 and an outer packaging body 90, and the electrode laminated body 50 is provided in the interior of the outer packaging body 90.

### Electrode Laminated Body 50

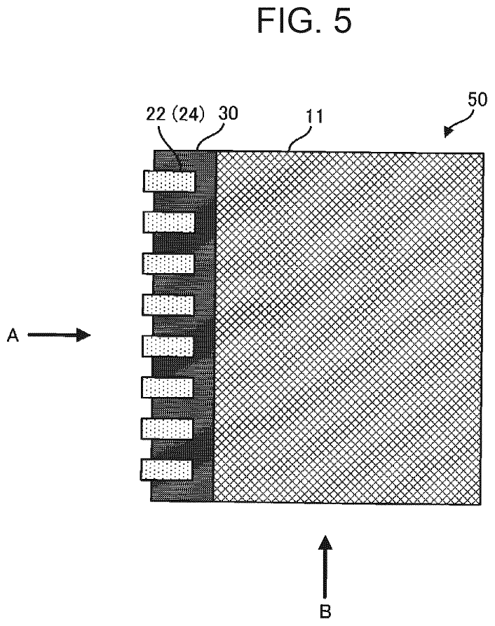

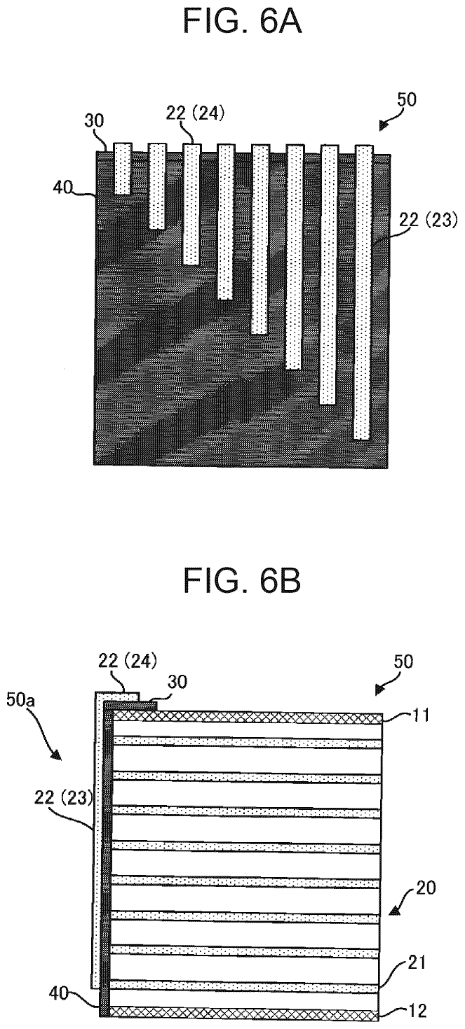

The electrode laminated body 50 will be described. FIG. 5 shows a plan view of the electrode laminated body 50. FIG. 6A shows an elevational view of the electrode laminated body 50 as viewed from an A-direction in FIG. 5, and FIG. 6B shows a side view of the electrode laminated body 50 as viewed from a B-direction in FIG. 5.

The electrode laminated body 50 is a laminated body that has a rectangular shape in lamination-directional view (thickness-directional view) and that includes current collectors (a positive electrode current collector and a negative electrode current collector), a positive electrode layer, a negative electrode layer, and an electrolyte layer. In the electrode laminated body 50, the number of laminated layers is not particularly limited, and may be appropriately set depending on purpose. The lamination form of the electrode laminated body 50 is not particularly limited, and may be a monopolar type, or may be a bipolar type. The electrode laminated body 50 may be a liquid state battery, or may be a solid state battery. The electrode laminated body 50 may be a lithium-ion battery, may be a sodium-ion battery, or may be a nickel-hydrogen battery, or the like. The electrode laminated body 50 may be a primary battery, or may be a secondary battery.

### Material of Electrode Laminated Body 50

The materials of the respective layers that constitute the electrode laminated body 50 will be described with typical examples. However, the materials of the respective layers that constitute the electrode laminated body 50 are not limited to the typical examples.

The current collector is a sheet-shaped conductive member. Examples of the current collector include a metal foil composed of stainless steel, iron, copper, aluminum, titanium, nickel, or the like. The metal foil may be composed of an alloy that contains two or more kinds of these metals. Further, for the metal foil, a predetermined surface treatment such as plating may be performed. The current collector may be constituted by a plurality of metal foils. In this case, the metal foils may be united by an adhesive or the like, or may be united by pressing or the like. The shape of the current collector may be a rectangular shape. The thickness of the current collector is not particularly limited, and is 1 μm to 1 mm, for example.

The positive electrode layer contains at least a positive electrode active material. The positive electrode active material is not particularly limited, and an arbitrary material may be appropriately selected depending on intended battery performance. For example, there are a composite oxide, a metallic lithium, sulfur, and the like. For example, the composition of the composite oxide includes at least one of iron, manganese, titanium, nickel, cobalt, and aluminum, and lithium. Examples of the composite oxide include olivine lithium iron phosphate (LiFePO₄).

The positive electrode layer may arbitrarily contain a conductive auxiliary agent. The conductive auxiliary agent is not particularly limited, and an arbitrary material may be appropriately selected depending on intended battery performance. For example, there are carbon materials such as acetylene black, carbon black, and graphite.

The positive electrode layer may arbitrarily contain a binding agent. The binding agent is not particularly limited, and an arbitrary material may be appropriately selected depending on intended battery performance. For example, there are a rubber resin, a fluoride resin, and the like.

The positive electrode layer may arbitrarily contain a solid electrolyte. The solid electrolyte is not particularly limited, and an arbitrary material may be appropriately selected depending on intended battery performance. For example, there are a solid oxide electrolyte, a solid sulfide electrolyte, and the like.

The positive electrode layer may have a rectangular shape. The thickness of the positive electrode layer is not particularly limited, and is in a range of 1 μm to 1 mm, for example. The area of the positive electrode layer may be smaller than the area of the negative electrode layer. The content of each material in the positive electrode layer is not particularly limited, and may be appropriately set depending on intended battery performance. The positive electrode layer may contain materials other than the above materials.

The negative electrode layer contains a negative electrode active material. The negative electrode active material is not particularly limited, and an arbitrary material may be appropriately selected depending on intended battery performance. For example, there are a carbon material such as black lead, artificial black lead, hard carbon, and soft carbon, a metallic compound, an element that can alloy together with lithium, a compound of the element that can alloy together with lithium, and the like. Examples of the element that can alloy together with lithium include silicon and tin.

The negative electrode layer may arbitrarily contain a conductive auxiliary agent. The conductive auxiliary agent is not particularly limited, and an arbitrary material may be appropriately selected depending on intended battery performance. For example, a conductive auxiliary agent that can be applied to the positive electrode layer may be appropriately selected.

The negative electrode layer may arbitrarily contain a binding agent. The binding agent is not particularly limited, and an arbitrary material may be appropriately selected depending on intended battery performance. For example, a binding agent that can be applied to the positive electrode layer may be appropriately selected.

The negative electrode layer may arbitrarily contain a solid electrolyte. The solid electrolyte is not particularly limited, and an arbitrary material may be appropriately selected depending on intended battery performance. For example, a solid electrolyte that can be applied to the positive electrode layer may be appropriately selected.

The negative electrode layer may have a rectangular shape. The thickness of the negative electrode layer is not particularly limited, and is in a range of 1 μm to 1 mm, for example. From a standpoint of output enhancement, the area of the negative electrode layer may be larger than the area of the positive electrode layer. The content of each material in the negative electrode layer is not particularly limited, and may be appropriately set depending on intended battery performance. The negative electrode layer may contain materials other than the above materials.

In the case where the electrolyte layer is a liquid electrolyte layer, the electrolyte layer contains a separator and an electrolytic solution. The separator is mainly a porous polyolefin sheet. The electrolytic solution is a solution in which a supporting electrolyte is dissolved in a nonaqueous solvent. As the nonaqueous solvent, there are carbonate solvents, ether solvents, ester solvents, and the like. As the supporting electrolyte, for example, there are LiPF₆, LiBF₄, lithium bis (fluorosulfonyl) imide (LiFSI), lithium bis (trifluoromethane) sulfonimide (LiTFSI), and the like.

In the case where the electrolyte layer is a solid electrolyte layer, the electrolyte layer contains a solid electrolyte. Further, the solid electrolyte layer may contain a binding agent. The solid electrolyte and the binding agent may be appropriately selected from the above-described solid electrolytes and bonding agents.

The electrolyte layer may have a rectangular shape. The thickness of the electrolyte layer is not particularly limited, and is in a range of 1 μm to 1 mm, for example.

### End-Surface Positive Electrode Current Collector 11, End-Surface Negative Electrode Current Collector 12, Internal Current Collector 20

As shown in FIG. 5, FIG. 6A, and FIG. 6B, the electrode laminated body 50 includes a positive electrode current collector (also referred to as an “end-surface positive electrode current collector 11” in the present specification) disposed on one surface in the lamination direction (thickness direction) and a negative electrode current collector (also referred to as an “end-surface negative electrode current collector 12” in the present specification) disposed on the other surface in the lamination direction. Further, the electrode laminated body 50 includes current collectors (also referred to as an “internal current collectors 20” in the present specification) in the interior. Layers other than the end-surface positive electrode current collector 11, the end-surface negative electrode current collector 12, and the internal current collectors 20 vary depending on an intended battery, and therefore are not specifically illustrated in FIG. 6B.

The number of internal current collectors 20 is not particularly limited, and may be appropriately set depending on purpose. In FIG. 5, FIG. 6A, and FIG. 6B, a plurality of internal current collectors 20 (eight internal current collectors 20) is disposed in the interior of the electrode laminated body 50. The internal current collectors 20 may be positive electrode current collectors, or may be negative electrode current collectors. Further, the internal current collectors 20 may be an identical kind of current collectors, or may be different kinds of current collectors. The internal current collectors 20 play a role in providing battery information to the exterior, as described later, and therefore, all internal current collectors 20 may be constituted by an identical kind of current collectors (preferably, positive electrode current collectors). Further, the electrode laminated body 50 may include, in the interior, an ordinary current collector other than the internal current collectors 20.

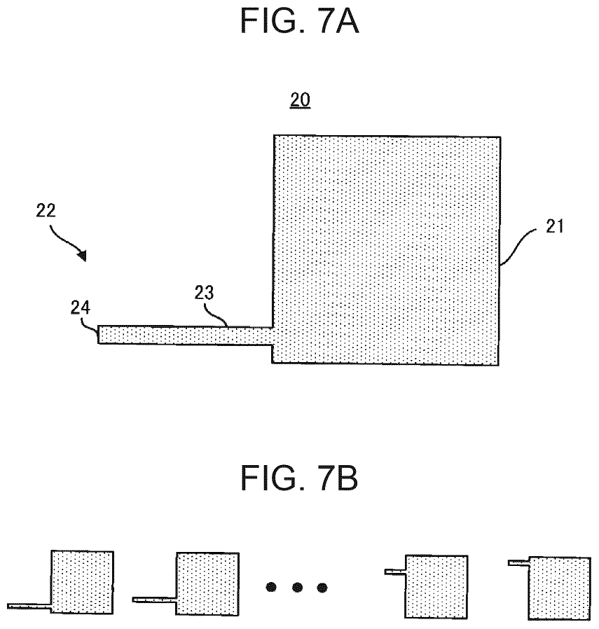

As a characteristic, the internal current collector 20 includes a connection portion 22 that is drawn out from a side surface of the electrode laminated body 50, unlike the other current collectors. FIG. 7A shows a plan view of the internal current collector 20, and FIG. 7B shows a plurality of internal current collectors 20 for describing differences in the position of the connection portion 22.

As shown in FIG. 7A, the internal current collector 20 includes a main body portion 21 and the connection portion 22. The main body portion 21 is a portion that is laminated in the interior of the electrode laminated body 50 and that functions as a current collector. Accordingly, on the main body portion 21, the positive electrode layer or negative electrode layer is laminated. The main body portion 21 has a rectangular shape. On the other hand, the connection portion 22 is a portion for providing the battery information (information about voltage, electric current, and the like) to the exterior, and has an elongated belt shape. For example, the connection portion 22 is used as a voltage monitoring line. As shown in FIG. 5, FIG. 6A, and FIG. 6B, the connection portion 22 is formed so as to be drawn out from a side surface 50a of the electrode laminated body 50, and the drawn-out connection portion 22 is folded in the lamination direction. Moreover, an end portion of the connection portion 22 is further folded, and is disposed on the identical surface to the surface on which the end-surface positive electrode current collector 11 is disposed. In this way, the connection portion 22 is characterized in that the connection portion 22 extends along the side surface 50a of the electrode laminated body 50 in the lamination direction and is disposed on the identical surface to the surface on which the end-surface positive electrode current collector 11 is disposed.

Conventional batteries have a shape in which the connection portion to function as the voltage monitoring line is merely drawn out in a side surface direction. On the other hand, in the electrode laminated body 50, the connection portion 22 has a portion that extends along the side surface of the electrode laminated body 50 in the lamination direction, and thereby, it is possible to reduce the area of the connection portion 22 on the whole of the battery 100. Accordingly, the electrode laminated body 50 makes it possible to enhance structural efficiency.

In the connection portion 22, a portion that is drawn out from the side surface of the electrode laminated body 50 and that extends along the side surface 50a in the lamination direction is referred to as an extension portion 23, and a portion that is disposed on the identical surface to the surface on which the end-surface positive electrode current collector 11 is disposed is referred to as an end portion 24.

As shown in FIG. 7B, the position of the connection portion 22 in the internal current collector 20 is not particularly limited, but as shown in FIG. 5, FIG. 6A, and FIG. 6B, the connection portions 22 drawn out from the plurality of internal current collectors 20 may be disposed so as not to overlap with each other in lamination-directional view. Thereby, it is possible to restrain the contact among the connection portions 22, and to simplify the battery structure. Further, as shown in FIG. 7B, the length of the connection portion 22 may be arbitrarily set depending on the position of the end portion 24.

Here, “the connection portion 22 is disposed on the identical surface to the surface on which the end-surface positive electrode current collector 11 is disposed” will be further described. As shown in FIG. 5, FIG. 6A, and FIG. 6B, the end portion 24 of the connection portion 22 is disposed on the end-surface positive electrode current collector 11 through an end-surface insulation layer 30. Therefore, strictly speaking, the end portion 24 of the connection portion 22 is not disposed on the identical surface to the surface on which the end-surface positive electrode current collector 11 is disposed. However, the end-surface insulation layer 30 is a very thin layer, and therefore, it can be said that the end portion 24 of the connection portion 22 and the end-surface positive electrode current collector 11 are disposed on the identical surface, from a standpoint of use. Accordingly, “the connection portion 22 is disposed on the identical surface to the surface on which the end-surface positive electrode current collector 11 is disposed” does not strictly mean that the end portion 24 of the connection portion 22 is disposed on the identical surface to the surface on which the end-surface positive electrode current collector 11 is disposed, and means that the end portion 24 of the connection portion 22 only needs to be disposed on the identical surface to the surface on which the end-surface positive electrode current collector 11 is disposed from a standpoint of use.

In the electrode laminated body 50, the connection portion 22 is disposed on the identical surface to the place on which the end-surface positive electrode current collector 11 is disposed, but the present disclosure is not limited to this. The connection portion 22 may be disposed on the identical surface to the surface on which the end-surface negative electrode current collector 12 is disposed.

Accordingly, the electrode laminated body 50 only needs to be configured such that a first end-surface current collector is disposed on one surface in the lamination direction, a second end-surface current collector is disposed on the other surface in the lamination direction, the internal current collectors 20 are laminated in the interior of the electrode laminated body 50, the internal current collectors 20 include the connection portions 22 drawn out from the side surface 50a of the electrode laminated body 50, and the connection portions 22 extend along the side surface 50a of the electrode laminated body 50 in the lamination direction and are disposed on the identical surface to the surface on which the first end-surface current collector is disposed. In the case where the first end-surface current collector is the end-surface positive electrode current collector 11, the second end-surface current collector is the end-surface negative electrode current collector 12. In the case where the first end-surface current collector is the end-surface negative electrode current collector 12, the second end-surface current collector is the end-surface positive electrode current collector 11.

### End-Surface Insulation Layer 30

The electrode laminated body 50 includes the end-surface insulation layer 30. The end-surface insulation layer 30 is disposed on at a part of the end-surface positive electrode current collector 11. Moreover, the connection portions 22 (the end portions 24) are disposed on the end-surface positive electrode current collector 11 through the end-surface insulation layer 30, and the end portions 24 and the end-surface positive electrode current collector 11 are insulated by the end-surface insulation layer 30. In this way, the end-surface insulation layer 30 is disposed between the end portions 24 and the end-surface positive electrode current collector 11, and plays a role in insulating the end portions 24 and the end-surface positive electrode current collector 11.

The material of the end-surface insulation layer 30 is not particularly limited, and for example, there are polyimide, polypropylene, polyethylene, polyvinylchloride, polytetrafluoroethylene, and the like. The thickness of the end-surface insulation layer 30 is not particularly limited, and is 5 μm to 300 μm, for example. The disposition method for the end-surface insulation layer 30 is not particularly limited, and for example, a resin tape may be sticked to the end-surface positive electrode current collector 11. Further, a resin sheet may be disposed between the end-surface positive electrode current collector 11 and the end portions 24 of the connection portions 22. Alternatively, a resin material may be applied to the end-surface positive electrode current collector 11.

The end-surface insulation layer 30 may be disposed on the end portions 24. Even when the end-surface insulation layer 30 is disposed on the end portions 24, the end portions 24 and the end-surface positive electrode current collector 11 can be insulated by the end-surface insulation layer 30. Accordingly, the end-surface insulation layer 30 only needs to be disposed between the end portions 24 and the end-surface positive electrode current collector 11.

### Side-Surface Insulation Layer 40

The electrode laminated body 50 includes a side-surface insulation layer 40. The side-surface insulation layer 40 is disposed on the side surface 50a of the electrode laminated body 50. Moreover, the connection portions 22 (the extension portions 23) and the side surface 50a of the electrode laminated body 50 are insulated by the side-surface insulation layer 40. In this way, the side-surface insulation layer 40 is disposed on the side surface 50a, and plays a role in insulating the extension portions 23 and the side surface 50a. Accordingly, the side-surface insulation layer 40 only needs to be disposed on at least a part of the side surface 50a. The side-surface insulation layer 40 may be disposed on the whole of the side surface 50a.

The material of the side-surface insulation layer 40 is not particularly limited, and for example, there are polyimide, polypropylene, polyethylene, polyvinylchloride, polytetrafluoroethylene, and the like. The thickness of the side-surface insulation layer 40 is not particularly limited, and is 5 μm to 300 μm, for example. The disposition method for the side-surface insulation layer 40 is not particularly limited, and for example, a resin tape may be sticked to the side surface 50a of the electrode laminated body 50. Further, a resin sheet may be disposed between the side surface 50a of the electrode laminated body 50 and the extension portions 23 of the connection portions 22. Alternatively, a resin material may be applied to the side surface 50a of the electrode laminated body 50.

The side-surface insulation layer 40 may be disposed on the extension portions 23. Even when the side-surface insulation layer 40 is disposed on the extension portions 23, the extension portions 23 and the side surface 50a of the electrode laminated body 50 can be insulated by the side-surface insulation layer 40. Accordingly, the side-surface insulation layer 40 only needs to be disposed on at least one of the extension portions 23 and the side surface 50a of the electrode laminated body 50.

### Lamination Form of Electrode Laminated Body 50

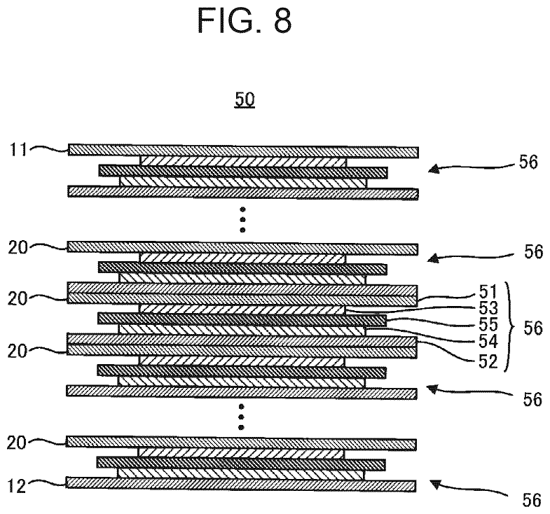

As described above, the electrode laminated body 50 is a laminated body that includes the current collectors, the positive electrode layer, the electrolyte layer, and the negative electrode layer. The end-surface current collectors 11, 12 are laminated on both surfaces of the electrode laminated body 50 in the lamination direction, and the plurality of internal current collectors 20 is included in the interior of the electrode laminated body 50. The other configuration is not particularly limited. FIG. 6A and FIG. 6B show sectional views of the electrode laminated body 50 that is an example. The electrode laminated body 50 shown in FIG. 8 is an electrode laminated body for a bipolar-type lithium-ion secondary battery.

As shown in FIG. 8, in the electrode laminated body 50, a plurality of electrode bodies 56 is laminated. In the electrode laminated body 50, the number of electrode bodies 56 is not particularly limited, and may be appropriately set depending on purpose.

The electrode body 56 includes a positive electrode current collector 51, a negative electrode current collector 52, a positive electrode layer 53, a negative electrode layer 54, and an electrolyte layer 55. The electrode body 56 is formed by overlapping the negative electrode layer 54 disposed on an upper surface of the negative electrode current collector 52 and the positive electrode layer 53 disposed on a lower surface of the positive electrode current collector 51 such that the electrolyte layer 55 is interposed. Moreover, the electrode laminated body 50 is formed such that the plurality of electrode bodies 56 is laminated so as to be connected in series.

The positive electrode current collector 51 disposed on one surface of the electrode laminated body 50 in the lamination direction corresponds to the end-surface positive electrode current collector 11, and the negative electrode current collector 52 disposed on the other surface in the lamination direction corresponds to the end-surface negative electrode current collector 12. Further, the positive electrode current collector 51 or the negative electrode current collector 52 included in the interior of the electrode laminated body 50 corresponds to the internal current collector 20. In FIG. 8, the internal current collector 20 is the positive electrode current collector 51 included in the interior of the electrode laminated body 50.

### Outer Packaging Body 90

The outer packaging body 90 is composed of metal. As shown in FIG. 3, FIG. 4A, and FIG. 4B, the outer packaging body 90 has a rectangular shape in thickness-directional view. The outer packaging body 90 is a box-shaped member having a space in which the electrode laminated body 50 can be housed in the interior.

### Basic Structure of Outer Packaging Body 90

First, a basic configuration of the outer packaging body 90 will be described. The outer packaging body 90 includes a positive electrode outer packaging body 91 and a negative electrode outer packaging body 92. Further, the outer packaging body 90 includes insulating resins 93, 94.

The positive electrode outer packaging body 91 is composed of metal, and has a box shape in which a rectangular bottom plate 91a and four side plates 91b sharing the sides of the bottom plate 91a are included. That is, the positive electrode outer packaging body 91 has such a shape that a section has a U-shape. Further, in the positive electrode outer packaging body 91, a surface that faces the bottom plate 91a is opened. The negative electrode outer packaging body 92 is composed of metal, and has a box shape in which a rectangular bottom plate 92a and four side plates 92b sharing the sides of the bottom plate 92a are included. That is, the negative electrode outer packaging body 92 has such a shape that a section has a U-shape. Further, in the negative electrode outer packaging body 92, a surface that faces the bottom plate 92a is opened. Moreover, the positive electrode outer packaging body 91 and the negative electrode outer packaging body 92 are overlapped with each other, such that the bottom plates face each other in the lamination direction and the side plates face each other in a direction orthogonal to the lamination direction. Thereby, the space in which the electrode laminated body 50 can be housed can be formed in the interior of the outer packaging body 90.

The bottom plate 91a of the positive electrode outer packaging body 91 is formed so as to have a larger area than the bottom plate 92a of the negative electrode outer packaging body 92. Therefore, when the electrode laminated body 50 is housed in the outer packaging body 90, the side plates 92b of the negative electrode outer packaging body 92 are disposed on the inside of the side plates 91b of the positive electrode outer packaging body 91.

The metal composing the positive electrode outer packaging body 91 and the negative electrode outer packaging body 92 is not particularly limited, and for example, there are aluminum, an aluminum alloy, stainless steel, copper, a cooper alloy, nickel steel, and the like. The thickness of the positive electrode outer packaging body 91 and the negative electrode outer packaging body 92 are not particularly limited, and are 0.05 mm or more and 2.0 mm or less, for example.

The resin 93 is disposed between the side surface of the electrode laminated body 50 and the side plates 92b of the positive electrode outer packaging body 91. Thereby, the side surface of the electrode laminated body 50 and the side plates 92b of the positive electrode outer packaging body 91 can be insulated, and can be fixed. The resin 94 is disposed between the side plates 91b of the positive electrode outer packaging body 91 and the side plates 92b of the negative electrode outer packaging body 92. Thereby, the side plates 91b of the positive electrode outer packaging body 91 and the side plates 92b of the negative electrode outer packaging body 92 can be insulated, and can be fixed.

The above basic configuration of the outer packaging body 90 is described in Japanese Patent Application No. 2023-006850, for example.

### Characteristic Structure of Outer Packaging Body 90

Subsequently, a characteristic portion of the outer packaging body 90 will be described. The outer packaging body 90 includes a positive electrode terminal 61 disposed on one surface in the thickness direction, a negative electrode terminal 62 disposed on the other surface in the thickness direction, and a plurality of connection terminals 70 (70a to 70h) disposed on the identical surface to the surface on which the positive electrode terminal 61 is disposed.

The positive electrode terminal 61 is the bottom plate 91a of the positive electrode outer packaging body 91, and is a portion that is exposed to the exterior. Typically, on an inner surface of the bottom plate 91a of the positive electrode outer packaging body 91, an insulation layer may be disposed at a portion other than a portion that contacts with the end-surface positive electrode current collector 11, and on an outer surface of the bottom plate 91a, an insulation layer 95 may be disposed at a portion other than a portion that is connected to the exterior (see FIG. 3; not illustrated in FIG. 4A and FIG. 4B). In this case, the positive electrode terminal 61 is a portion that is on the bottom plate 91a of the positive electrode outer packaging body 91 and that is exposed to the exterior such that the insulation layer is not disposed. The same goes for the negative electrode terminal 62. The negative electrode terminal 62 is the bottom plate 92a of the negative electrode outer packaging body 92, and is a portion that is exposed to the exterior. Typically, on an inner surface of the bottom plate 92a of the negative electrode outer packaging body 92, an insulation layer may be disposed at a portion other than a portion that contacts with the end-surface negative electrode current collector 12, and on an outer surface of the bottom plate 92a, an insulation layer may be disposed at a portion other than a portion that is connected to the exterior. In this case, the negative electrode terminal 62 is a portion that is on the bottom plate 92a of the negative electrode outer packaging body 92 and that is exposed to the exterior such that the insulation layer is not disposed.

Both surfaces of the side plate 91b of the positive electrode outer packaging body 91 and both surfaces of the side plate 92b of the negative electrode outer packaging body 92 may be covered with insulation layers. Thereby, inner surfaces of the side plates of the outer packaging body 90 (inner surfaces of the side plates 92b of the negative electrode outer packaging body 92) and the electrode laminated body 50 can be insulated. Further, outer surfaces of the side plates of the outer packaging body 90 (outer surfaces of the side plates 91b of the positive electrode outer packaging body 91) and an external member can be insulated.

In the interior of the outer packaging body 90, the positive electrode terminal 61 contacts directly with the end-surface positive electrode current collector 11 of the electrode laminated body 50, and is electrically connected to the end-surface positive electrode current collector 11 of the electrode laminated body 50. In the interior of the outer packaging body 90, the negative electrode terminal 62 contacts directly with the end-surface negative electrode current collector 12 of the electrode laminated body 50, and is electrically connected to the end-surface negative electrode current collector 12 of the electrode laminated body 50. Accordingly, both end surfaces of the outer packaging body 90 in the lamination direction function as terminals. In this way, the positive electrode terminal 61 and the negative electrode terminal 62 are electrically connected to the end-surface positive electrode current collector 11 and the end-surface negative electrode current collector 12 of the electrode laminated body 50, in the interior of the outer packaging body 90, and therefore, airtight property and gas barrier property are assured.

The positive electrode terminal 61 and the end-surface positive electrode current collector 11 contact directly with each other and are electrically connected in the interior of the outer packaging body 90, from a standpoint of structural efficiency, but the present disclosure is not limited to this form. The positive electrode terminal 61 and the end-surface positive electrode current collector 11 may be electrically connected indirectly through a conductive member or the like, in the interior of the outer packaging body 90. The same goes for the negative electrode terminal 62.

The connection terminals 70 are electrically connected to the connection portions 22 (the end portions 24) of the electrode laminated body 50, and play a role in providing information about the electrode laminated body 50 to the exterior. The connection terminals 70 are disposed on the bottom plate 91a of the positive electrode outer packaging body 91. That is, the connection terminals 70 are disposed on the identical surface to the surface on which the positive electrode terminal 61 is disposed. In the interior of the outer packaging body 90, the connection terminals 70 contact directly with the end portions 24 of the connection portions 22, and are electrically connected to the end portions 24 of the connection portions 22. The number of connection terminals 70 corresponds to the number of connection portions 22, and the connection terminals 70 are connected to the connection portions 22, respectively.

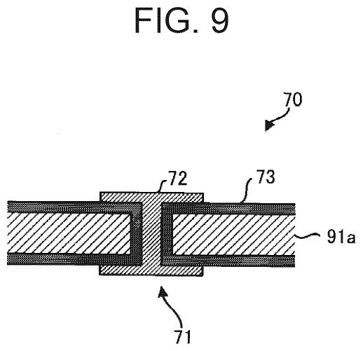

A specific configuration of the connection terminal 70 will be described. FIG. 9 shows a partial sectional view focusing on the connection terminal 70. As shown in FIG. 9, the connection terminal 70 includes a through-hole 71 that passes through the end surface of the outer packaging body 90 (the bottom plate 91a of the positive electrode outer packaging body 91) in the lamination direction, a metal portion 72 that is disposed in the through-hole 71, and an insulation layer 73 that is disposed between the through-hole 71 and the metal portion 72.

The through-hole 71 passes through the end surface of the outer packaging body 90 (the bottom plate 91a of the positive electrode outer packaging body 91) in the lamination direction. The size of the through-hole 71 is not particularly limited, and may be appropriately set depending on purpose. For example, the size of the through-hole 71 may be 0.05 mm to 1.0 mm. The shape of the through-hole 71 is not particularly limited, and is typically a circular shape.

The metal portion 72 is a portion that contacts directly with the end portion 24 of the connection portion 22 and is electrically connected to the end portion 24 of the connection portion 22 in the interior of the outer packaging body 90. Since the metal portion 72 is connected to the end portion 24 of the connection portion 22 in the interior of the outer packaging body 90, airtight property and gas barrier property are assured. The metal composing the metal portion 72 is not particularly limited. For example, there are copper, gold, silver, nickel, chrome, and the like. The metal portion 72 may be disposed only in the through-hole 71. However, from a standpoint of increase in connectivity, in addition to the interior of the through-hole 71, the metal portion 72 may be disposed on an inner surface peripheral portion and outer surface peripheral portion of the outer packaging body 90 (the bottom plate 91a of the positive electrode outer packaging body 91) that are continuous with the through-hole 71.

The metal portion 72 and the end portion 24 of the connection portion 22 contact directly with each other and are electrically connected in the interior of the outer packaging body 90, from a standpoint of enhancement in structural efficiency, but the present disclosure is not limited to this form. The metal portion 72 and the end portion 24 of the connection portion 22 may be electrically connected indirectly through a conductive member or the like, in the interior of the outer packaging body 90.

The insulation layer 73 plays a role in insulating the metal portion 72 and the outer packaging body 90 (the positive electrode outer packaging body 91). The insulation layer 73 is disposed between the outer packaging body 90 (the positive electrode outer packaging body 91) and the metal portion 72. In the case where the metal portion 72 is disposed only in the interior of the through-hole 71, the insulation layer 73 may be disposed only on an inside portion of the through-hole 71. In the case where the metal portion 72 is disposed in the interior of the through-hole 71 and on the inner surface peripheral portion and outer surface peripheral portion of the outer packaging body 90 (the bottom plate 91a of the positive electrode outer packaging body 91) that are continuous with the through-hole 71, the insulation layer 73 may be disposed on the inside portion of the through-hole 71 and on an inside peripheral portion and outside peripheral portion of the outer packaging body 90 that are continuous with the through-hole 71. Typically, as described above, the insulation layer 95 is disposed at the portion other than the positive electrode terminal 61 on the bottom plate 91a of the positive electrode outer packaging body 91. Accordingly, typically, the insulation layer 73 constitutes a part of the insulation layer 95, and is disposed on the inside portion of the through-hole 71 and on the inside peripheral portion and outside peripheral portion of the outer packaging body 90 that are continuous with the through-hole 71.

The material of the insulation layer 73 is not particularly limited, and for example, there are polyimide, polypropylene, polyethylene, polyvinylchloride, polytetrafluoroethylene, and the like.

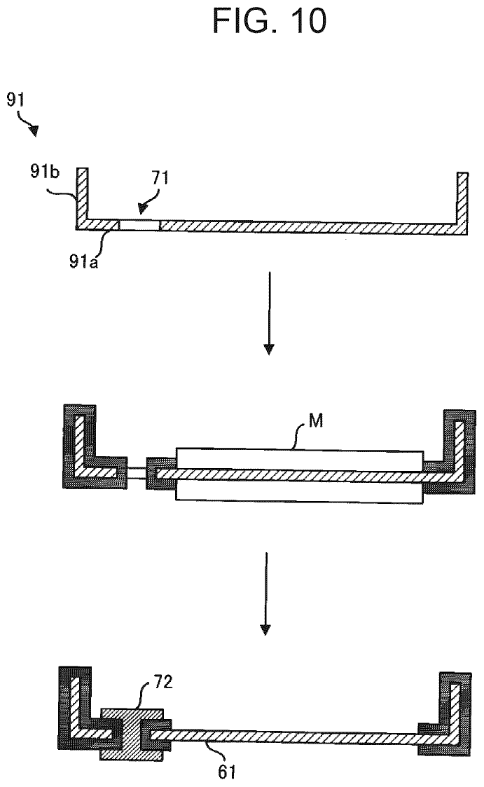

The method for providing the connection terminal 70 on the outer packaging body 90 is not particularly limited, and for example, there is the following method. FIG. 10 shows an example of the method for providing the connection terminal 70 on the outer packaging body 90. FIG. 10 is a sectional view of the positive electrode outer packaging body 91. First, the through-hole 71 is provided at a predetermined position on the bottom plate 91a of the positive electrode outer packaging body 91. Subsequently, a portion of the bottom plate 91a that will become the positive electrode terminal 61 is covered with a predetermined masking member M, and an insulation layer is disposed on the other portion of the bottom plate 91a. Then, the metal portion 72 is disposed in the through-hole 71 provided with the insulation layer 73. Examples of the method for disposing the metal portion 72 include plate processing.

In the battery 100, in the interior of the outer packaging body 90, the end-surface positive electrode current collector 11 and the positive electrode terminal 61 are electrically connected, the end-surface negative electrode current collector 12 and the negative electrode terminal 62 are electrically connected, and the connection portions 22 and the connection terminals 70 are electrically connected. Accordingly, in the battery 100, airtight property and gas barrier property are enhanced. Further, in the battery 100, the end-surface electrode terminal and the connection terminals are disposed on the identical surface. Accordingly, in the battery 100, structural efficiency is enhanced for the same reason as the electrode laminated body 50.

### Connection Member 500

Subsequently, the connection member 500 will be described. The connection member 500 includes a first-terminal connection portion, a second-terminal connection portion, and a connection-terminal connection portion 400. A mode in which the first-terminal connection portion is used as a positive-electrode-terminal connection portion 200 and the second-terminal connection portion is used as a negative-electrode-terminal connection portion 300 will be described below. However, the first-terminal connection portion may be the negative-electrode-terminal connection portion, and the second-terminal connection portion may be the positive-electrode-terminal connection portion. The first-terminal connection portion and the second-terminal connection portion are set so as to be connected to heteropolar electrodes, respectively.

As shown in FIG. 1 and FIG. 2, the connection member 500 includes the positive-electrode-terminal connection portion 200, the negative-electrode-terminal connection portion 300, and the connection-terminal connection portion 400. In the assembled-battery structure 1000, the positive-electrode-terminal connection portion 200 and the connection-terminal connection portion 400 are integrated.

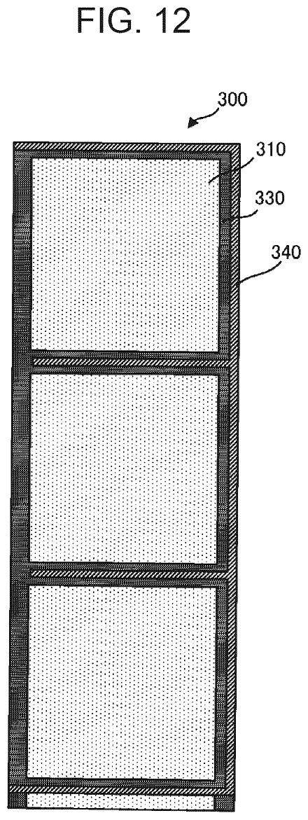

FIG. 11 shows a bottom view of the positive-electrode-terminal connection portion 200 and the connection-terminal connection portion 400. FIG. 12 shows a plan view of the negative-electrode-terminal connection portion 300.

### Positive-Electrode-Terminal Connection Portion 200, Negative-Electrode-Terminal Connection Portion 300

The positive-electrode-terminal connection portion 200 is a sheet-shaped member. As shown in FIG. 2 and FIG. 11, the positive-electrode-terminal connection portion 200 includes a first metal layer 210, and the first metal layer 210 contacts directly with the positive electrode terminals 61 of the batteries 100, and is electrically connected to the positive electrode terminals 61 of the batteries 100. The positive-electrode-terminal connection portion 200 includes a first base material layer 220 that supports the first metal layer 210. The positive-electrode-terminal connection portion 200 includes a first insulation layer 230 at the periphery of a portion of the first metal layer 210 that is on a surface on the opposite side of the first base material layer 220 and that contacts with the positive electrode terminal 61.

Further, the positive-electrode-terminal connection portion 200 includes a first positioning portion 240 for guiding the battery 100 to an installation position. The first positioning portion 240 is composed of resin, and is formed so as to be convex from the first insulation layer 230. The first positioning portion 240 is configured to surround at least a part of the periphery of the positive electrode terminal 61. In FIG. 11, the first positioning portion 240 is formed so as to surround the positive electrode terminal 61 in a U-shape in plan view. By including the first positioning portion 240, it is possible to install the battery 100 at an appropriate position, and it is possible to secure the contact between the first metal layer 210 and the positive electrode terminal 61 and the contact between the terminals of the connection-terminal connection portion 400 and the connection terminals 70.

The same goes for the structure of the negative-electrode-terminal connection portion 300. That is, the negative-electrode-terminal connection portion 300 is a sheet-shaped member. The negative-electrode-terminal connection portion 300 includes a second metal layer 310, and the second metal layer 310 contacts directly with the negative electrode terminals 62 of the batteries 100, and is electrically connected to the negative electrode terminals 62 of the batteries 100. The negative-electrode-terminal connection portion 300 includes a second base material layer 320 that supports the second metal layer 310. The negative-electrode-terminal connection portion 300 includes a second insulation layer 330 at the periphery of a portion of the second metal layer 310 that is on a surface on the opposite side of the second base material layer 320 and that contacts with the negative electrode terminal 62.

Further, the negative-electrode-terminal connection portion 300 includes a second positioning portion 340 for guiding the battery 100 to an installation position. The second positioning portion 340 is composed of resin, and is formed on the second insulation layer 330. The second positioning portion 340 is configured to surround at least a part of the periphery of the negative electrode terminal 62. In FIG. 12, the second positioning portion 340 is formed so as to surround the negative electrode terminal 62 in a U-shape in plan view. By including the second positioning portion 340, it is possible to install the battery 100 at an appropriate position, and it is possible to secure the contact between the second metal layer 310 and the negative electrode terminal 62.

The metal composing the first metal layer 210 and the second metal layer 310 is not particularly limited, and for example, there are gold, silver, copper, aluminum, nickel, iron, and alloys containing these metals. The first base material layer 220, the second base material layer 320, the first insulation layer 230, the second insulation layer 330, the first positioning portion 240, and the second positioning portion 340 are composed of resin. As the resin, for example, there are polyethylene terephthalate, nylon, polymethyl methacrylate, polypropylene, polycarbonate, polyalkylene terephthalate, polyimide, epoxy resin, and the like.

The size of the positive-electrode-terminal connection portion 200 and the negative-electrode-terminal connection portion 300 is not limited as long as the batteries 100 can be sandwiched. The size does not need to be extremely larger than the batteries 100, and therefore, for example, such a size that the positive-electrode-terminal connection portion 200 and the negative-electrode-terminal connection portion 300 reach positions of 0.1 mm to 5.0 mm from edges of the batteries 100 can be adopted. In the case where terminals are provided at ends of the positive-electrode-terminal connection portion 200 and the negative-electrode-terminal connection portion 300, the length in the longitudinal direction may be increased as necessary.

The thickness of the positive-electrode-terminal connection portion 200 (other than the first positioning portion 240) and the negative-electrode-terminal connection portion 300 (other than the second positioning portion 340) may be appropriately set in consideration of the balance of a required flexibility degree and strength. For example, the thickness may be 0.005 mm to 1 mm.

As the method for bringing the battery 100 in contact with the positive-electrode-terminal connection portion 200 and the negative-electrode-terminal connection portion 300, a shrink film, a constraint band, an adhesive, ultrasonic welding, laser welding, electric welding, and the like may be used. The battery 100 may be fixed by being sandwiched by plates or the like from outsides in the thickness direction. Alternatively, the contacting may be performed using a spring or the like.

As described above, the positive electrode terminals 61 of the batteries 100 are electrically connected to the positive-electrode-terminal connection portion 200 (the first metal layer 210), and the negative electrode terminals 62 of the batteries 100 are electrically connected to the negative-electrode-terminal connection portion 300 (the second metal layer 310). Thereby, the batteries 100 are connected in parallel.

For the structures of the positive-electrode-terminal connection portion 200 and the negative-electrode-terminal connection portion 300, Japanese Patent Application No. 2023-065874 may be referred to.

### Connection-Terminal Connection Portion 400

The connection-terminal connection portion 400 is a sheet-shaped member, and includes a plurality of terminals, and connection elements are electrically connected to the terminals 70a to 70h of the batteries 100. The plurality of terminals is divided for each battery 100 that is connected, and groups of divided terminals are referred to as terminal groups 410 to 430. The terminal group 410 includes terminals 411a to 411h, the terminal group 420 includes terminals 421a to 421h, and the terminal group 430 includes terminals 431a to 431h. Further, the connection-terminal connection portion 400 includes a base plate 450 that supports the plurality of terminals, and the base plate 450 includes a plurality of terminal wires 440a to 440h in the interior. Furthermore, the connection-terminal connection portion 400 includes a connector convex portion 460 for bundling the terminal wires 440a to 440h and connecting the terminal wires 440a to 440h to the exterior.

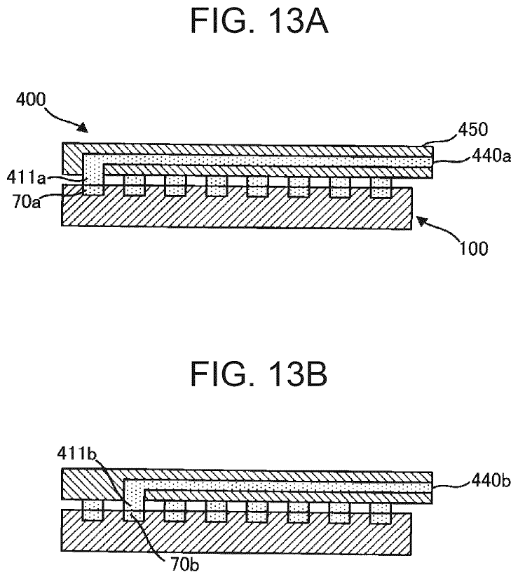

FIG. 13A and FIG. 13B show sectional views focusing on the terminal group 410. FIG. 13A shows a section on which the terminal 411a and the terminal wire 412a are connected. FIG. 13B shows a section on which the terminal 411b and the terminal wire 412b are connected.

As understood from FIG. 13A and FIG. 13B, the terminals 411a to 411h contact with the terminal wires 440a to 440h, and are electrically connected to the terminal wires 440a to 440h, in one-to-one relation. The reason why this structure is possible is because the connection-terminal connection portion 400 has a two-layer structure that is constituted by the base plate 450 and the plurality of terminals. Further, since the terminals 411a to 411h are connected to the connection terminals 70a to 70h of the battery 100, it is possible to obtain the battery information (the information about voltage, electric current, and the like) about the electrode laminated body 50 from the terminal wires 440a to 440h.

Similarly, each of the terminal groups 420, 430 is connected to the connection terminals 70a to 70h of the battery 100. Meanwhile, the terminal groups 420, 430 are connected to the same terminal wires 440a to 440h as the terminal group 410. That is, the terminal wires 440a to 440h are shared by the terminal groups 410 to 430, and the terminal groups 410 to 430 are connected in parallel. More specifically, the terminal wire 412a is connected to the terminals 411a, 421a, 431a. The terminal wire 412b is connected to the terminals 411b, 421b, 431b. The same goes for the terminal wires 440c to 440h. In this way, corresponding terminals of the terminal groups 410 to 430 are connected to one terminal wire in parallel. Thereby, it is possible to reduce the number of terminal wires, and to simplify the structure.

The assembled-battery structure 1000 is not limited to this manner. That is, the terminal wires do not need to be connected in parallel in the above way, and only one terminal may be connected to one terminal wire. Thereby, it is possible to obtain the battery information from individual terminals. Accordingly, the terminal wire only needs to be electrically connected to at least one terminal.

### Structural Characteristic of Positive-Electrode-Terminal Connection Portion 200 and Connection-Terminal Connection Portion 400

The positive-electrode-terminal connection portion 200 and the connection-terminal connection portion 400 are installed on the surface on which the positive electrode terminal 61 and connection terminals 70 of the battery 100 are disposed. That is, the positive-electrode-terminal connection portion 200 and the connection-terminal connection portion 400 are disposed on the identical surface. Conventionally, as in the case of the bipolar battery described in JP 2006-127857 A, the connection terminal that provides the battery information is drawn out from the battery side surface, and the connection-terminal connection portion is disposed on the battery side surface. However, in the assembled-battery structure 1000, the positive-electrode-terminal connection portion 200 and the connection-terminal connection portion 400 are disposed on the identical surface. Thereby, the increase in size in the side surface direction is restrained. Accordingly, with the assembled-battery structure 1000, it is possible to enhance structural efficiency.

Further, in the assembled-battery structure 1000, the connection-terminal connection portion 400 disposed on the identical surface to the surface on which the positive-electrode-terminal connection portion 200 is disposed is disposed on the battery 100 in which the positive electrode terminal 61 and the connection terminals 70 are disposed on the identical surface, and therefore, simply by installing the positive-electrode-terminal connection portion 200 and the connection-terminal connection portion 400 on the battery 100, these members are electrically connected. Accordingly, the assembled-battery structure 1000 does not require a complex connection work, and therefore, contributes to the reduction in production cost.

In addition, the positive-electrode-terminal connection portion 200 and the connection-terminal connection portion 400 are integrated. Thereby, handling becomes easy. However, the positive-electrode-terminal connection portion 200 and the connection-terminal connection portion 400 may be separate members.

### Flexibility of Connection Member 500

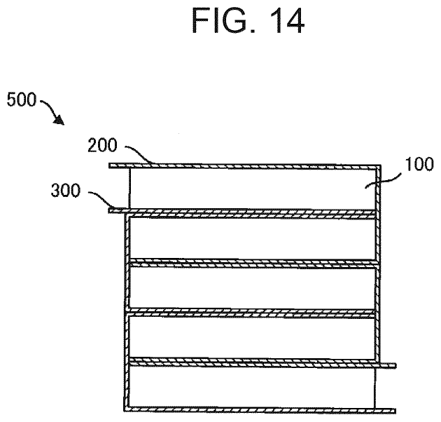

Each of the positive-electrode-terminal connection portion 200, the negative-electrode-terminal connection portion 300, and the connection-terminal connection portion 400 is a sheet-shaped member, and has flexibility. Particularly, in the positive-electrode-terminal connection portion 200, the negative-electrode-terminal connection portion 300, and the connection-terminal connection portion 400, a portion between batteries 100 that are adjacent in the longitudinal direction has flexibility. Thereby, the assembled-battery structure 1000 can adopt various forms, other than a form in which the batteries 100 are arrayed on a plane. For example, as shown in FIG. 14, a form in which batteries 100 are laminated in a zigzag manner is possible. In this case, the assembled-battery structure may be constrained using a constraint member such as a metal band, and the terminals may be brought in contact with the metal layer.

Different Mode about Positioning

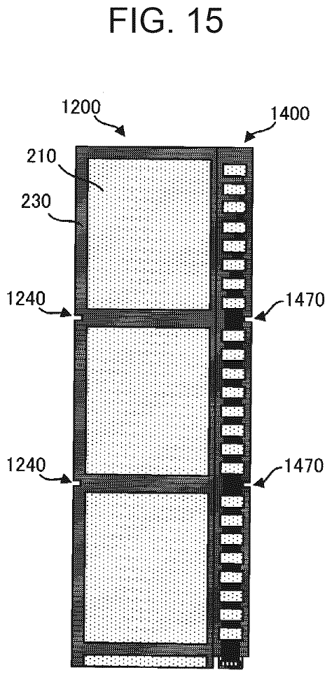

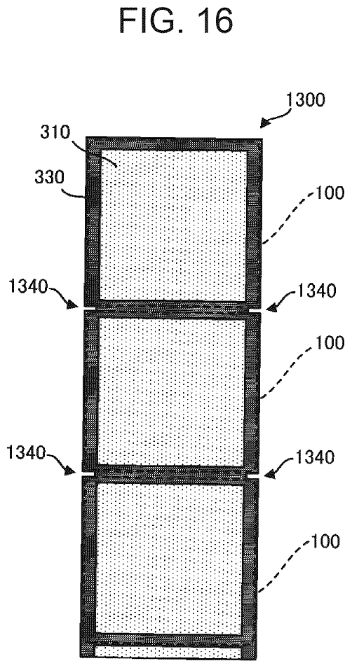

A connection member having a different mode about the positioning of the battery 100 will be described. In the different mode, a cutout makes it possible to guide the battery 100 to the installation position. FIG. 15 shows a bottom view of a positive-electrode-terminal connection portion 1200 and a connection-terminal connection portion 1400 in the different mode. FIG. 16 shows a plan view of a negative-electrode-terminal connection portion 1300 in the different mode. In FIG. 16, the batteries 100 disposed as reference are shown by dotted lines.

As shown in FIG. 15, the positive-electrode-terminal connection portion 1200 has almost the same configuration as the positive-electrode-terminal connection portion 200, but is different in that first cutouts 1240 are included instead of the first positioning portions 240. The connection-terminal connection portion 1400 includes third cutouts 1470 in addition to the configuration of the connection-terminal connection portion 400. In the positive-electrode-terminal connection portion 1200, each first cutout 1240 is formed at a portion (first joining portion) that is between batteries 100 adjacent in the longitudinal direction and that is an end portion on the opposite side of the connection-terminal connection portion 1400 in the shorter direction. In the connection-terminal connection portion 1400, each third cutout 1470 is formed at a position that corresponds to the above first joining portion in the longitudinal direction and that is an end portion on the opposite side of the positive-electrode-terminal connection portion 1200 in the shorter direction. Accordingly, the first cutout 1240 and the third cutout 1470 are formed so as to face each other.

Since the positive-electrode-terminal connection portion 1200 and the connection-terminal connection portion 1400 include the first cutouts 1240 and the third cutouts 1470, it is possible to install the batteries 100 at appropriate positions using the cutouts as marks, and it is possible to secure the contact between the first metal layer 210 and the positive electrode terminal 61 and the contact between the terminals of the connection-terminal connection portion 400 and the connection terminals 70. Further, by matching the longitudinal-directional sides of the positive-electrode-terminal connection portion 1200 and the connection-terminal connection portion 1400 with the longitudinal-directional sides of the batteries 100 and disposing the first cutouts 1240 and the third cutouts 1470 among the batteries 100 arrayed in the longitudinal direction (in the case where a terminal for external connection is not disposed at an end portion of the positive-electrode-terminal connection portion 1200 in the longitudinal direction, by matching the shorter-directional sides of the positive-electrode-terminal connection portion 1200 and the connection-terminal connection portion 1400 at the end portion with the shorter-directional sides of the batteries 100 disposed at the end portion), the positioning of the batteries 100 can be more easily performed by outer circumference portions of the positive-electrode-terminal connection portion 1200 and the connection-terminal connection portion 1400, the first cutouts 1240, and the third cutouts 1470. In this case, it is possible to increase the size of each battery 100 (or it is possible to decrease the sizes of the positive-electrode-terminal connection portion 1200 and the connection-terminal connection portion 1400), compared to the case where the positive-electrode-terminal connection portion 200 and the connection-terminal connection portion 400 are used.

As shown in FIG. 16, the negative-electrode-terminal connection portion 1300 has almost the same configuration as the negative-electrode-terminal connection portion 300, but is different in that second cutouts 1340 are included instead of the second positioning portions 340. In the negative-electrode-terminal connection portion 1300, the second cutouts 1340 are formed at portions (second joining portions) that are between batteries 100 adjacent in the longitudinal direction and that are both end portions in the shorter direction.

The effect of the negative-electrode-terminal connection portion 1300 is the same as that of the positive-electrode-terminal connection portion 1200 and the connection-terminal connection portion 1400. FIG. 16 shows a form in which the longitudinal-directional sides of the negative-electrode-terminal connection portion 1300 are matched with the longitudinal-directional sides of the batteries 100 and the second cutouts 1340 are disposed among the batteries 100 arrayed in the longitudinal direction. Further, in FIG. 16, a terminal for external connection is not disposed at one end portion of the negative-electrode-terminal connection portion 1300 in the longitudinal direction, and therefore, the shorter-directional side of the negative-electrode-terminal connection portion 1300 at the end portion is matched with one shorter-directional side of the battery 100 disposed at the end portion. As shown in FIG. 16, the negative-electrode-terminal connection portion 1300 makes it possible to increase the size of each battery 100 (or to decrease the size of the negative-electrode-terminal connection portion 1300), compared to the case where the negative-electrode-terminal connection portion 300 is used.

As described above, with the connection member in the different mode, it is possible to increase the size of each battery 100 (or to decrease the size of the connection member), and it is possible to further enhance the structural efficiency of the assembled-battery structure.

The assembled-battery structure in the present disclosure has been described above with the embodiment. With the assembled-battery structure in the present disclosure, it is possible to enhance structural efficiency.

### Composite Assembled-Battery Structure 2000

Next, a composite assembled-battery structure in the present disclosure will be described with use of a composite assembled-battery structure 2000 that is an embodiment.

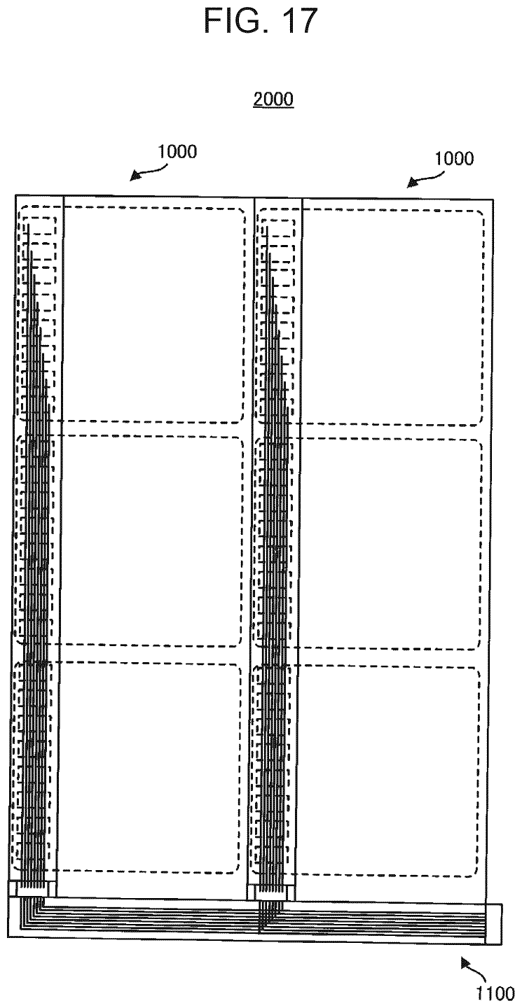

FIG. 17 shows a plan view of the composite assembled-battery structure 2000. As shown in FIG. 17, the composite assembled-battery structure 2000 includes a plurality of assembled-battery structures 1000 and a joining member 1100 for joining the plurality of assembled-battery structure 1000. The assembled-battery structure 1000 has been described above, and the description is omitted.

### Joining Member 1100

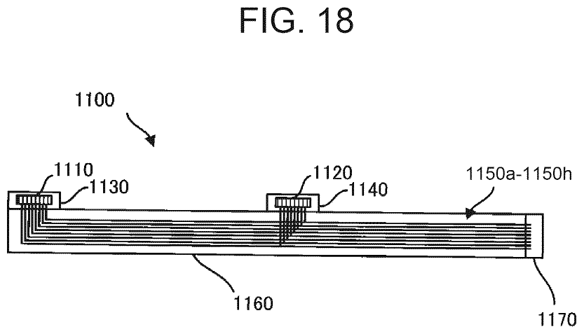

FIG. 18 shows a plan view in which only the joining member 1100 is taken out. The joining member 1100 includes a plurality of joining terminals, and the joining terminals are electrically connected to the terminal wires 440a to 440h of the assembled-battery structures 1000. The plurality of joining terminals is divided for each assembled-battery structure 1000 that is connected, and groups of divided terminals are referred to as joining terminal groups 1110, 1120. The joining member 1100 includes connector concave portions 1130, 1140 that house the joining terminal groups 1110, 1120, and the connector concave portions 1130, 1140 are connected to the connector convex portions 460 of the assembled-battery structures 1000. Thereby, the joining terminals included in the joining terminal groups 1110, 1120 are connected to the terminal wires 440a to 440h of the assembled-battery structures 1000. Further, the joining member 1100 includes a base plate 1160, and the base plate 1160 includes a plurality of joining terminal wires 1150a to 1150h in the interior. Furthermore, the joining member 1100 includes a connector 1170 for bundling the joining terminal wires 1150a to 1150h and connecting the joining terminal wires 1150a to 1150h to the exterior.

The joining terminals included in the joining terminal group 1110 contact with the joining terminal wires 1150a to 1150h of an assembled-battery structure 1000, and are electrically connected to the joining terminal wires 1150a to 1150h of the assembled-battery structure 1000, in one-to-one relation. Accordingly, it is possible to obtain the battery information (the information about voltage, electric current, and the like) about the electrode laminated body 50 included in the assembled-battery structure 1000, from the joining terminal wires 1150a to 1150h.

As for the joining terminal group 1120, similarly, the joining terminals included in the joining terminal group 1120 contact with the joining terminal wires 1150a to 1150h of the other assembled-battery structure 1000, and electrically connected to the joining terminal wires 1150a to 1150h of the assembled-battery structure 1000, in one-to-one relation. Meanwhile, the joining terminal group 1120 is connected to the same joining terminal wires 1150a to 1150h as the joining terminal group 1110. That is, the joining terminal wires 1150a to 1150h are shared by the joining terminal groups 1110, 1120, and the joining terminal groups 1110, 1120 are connected in parallel. This connection relation is the same as the connection relation between the terminal groups 410 to 430 and the terminal wires 440a to 440c in the assembled-battery structure 1000. Accordingly, corresponding joining terminals of the joining terminal groups 1110, 1120 are connected to one joining terminal wire in parallel. Thereby, it is possible to reduce the number of joining terminal wires, and to simplify the structure.

However, the composite assembled-battery structure 2000 is not limited to this manner. That is, the joining terminal wires do not need to be connected in parallel in the above way, and only one joining terminal may be connected to one joining terminal wire. Thereby, it is possible to obtain the battery information from individual joining terminals. Accordingly, the joining terminal wire only needs to be electrically connected to at least one joining terminal.

As shown in FIG. 15, the connection-terminal connection portions 400 of the assembled-battery structures 1000 and the joining member 1100 are disposed on the identical surface, and therefore, the composite assembled-battery structure 2000 contributes to enhancement in structural efficiency. Further, in the composite assembled-battery structure 2000, it is possible to easily connect the assembled-battery structures 1000 and the joining member 1100, simply by connecting the connector convex portions 460 included in the assembled-battery structures 1000 and the connector concave portions 1130, 1140 included in the joining member 1100.

In the composite assembled-battery structure 2000, the joining member 1100 is a separate member from the connection-terminal connection portion 400 of the assembled-battery structure, but without being limited to this form, the joining member 1100 and the connection-terminal connection portion 400 may be integrated.

The joining member 1100 is a sheet-shaped member and has flexibility, similarly to the positive-electrode-terminal connection portion 200, the negative-electrode-terminal connection portion 300, and the connection-terminal connection portion 400 of the assembled-battery structure 1000. Specifically, the base plate 1160 (including the joining terminal wires 1140a to 1140h) of the joining member 1100 has flexibility. Accordingly, the composite assembled-battery structure 2000 can adopt various forms, other than a form in which the assembled-battery structures 1000 are arrayed.

The composite assembled-battery structure in the present disclosure has been described above with the embodiment. The composite assembled-battery structure in the present disclosure includes the above-described assembled-battery structures, and makes it possible to enhance structural efficiency. Further, the composite assembled-battery structure makes it possible to easily join the above-described assembled-battery structures.

### Battery Structure, Composite Battery Structure

The assembled-battery structure in the present disclosure includes a plurality of batteries, but may include only one battery. That is, the present disclosure may provide a battery structure. Further, the present disclosure may provide a composite battery structure that includes a plurality of battery structures. The battery structure and the composite battery structure will be described below. Details of members have been described above.

The battery structure in the present disclosure includes a battery and a connection member connected to the battery, the battery includes a first terminal disposed on one surface in a thickness direction, a second terminal disposed on the other surface, and a plurality of connection terminals disposed on an identical surface to the surface on which the first terminal is disposed, the connection member includes a first-terminal connection portion, a second-terminal connection portion, and a connection-terminal connection portion, the first-terminal connection portion includes a first metal layer, the first metal layer is electrically connected to the first terminal of the battery, the second-terminal connection portion includes a second metal layer, the second metal layer is electrically connected to the second terminal of the battery, the connection-terminal connection portion includes a plurality of terminals, the terminals are electrically connected to the connection terminals of the battery, and the first-terminal connection portion and the connection-terminal connection portion are disposed on an identical surface.

The composite battery structure in the present disclosure includes a plurality of the above battery structures, and a joining member that joins the plurality of the battery structures, the joining member includes a plurality of joining terminals, and the joining terminals are electrically connected to terminal wires of the battery structures.

What is claimed is:

1. An assembled-battery structure comprising:
a plurality of batteries; and
a connection member connected to the plurality of batteries, wherein:
each of the batteries includes a first terminal disposed on one surface in a thickness direction, a second terminal disposed on the other surface in the thickness direction, and a plurality of connection terminals disposed on an identical surface to the surface on which the first terminal is disposed;
the connection member includes a first-terminal connection portion, a second-terminal connection portion, and a connection-terminal connection portion;
the first-terminal connection portion includes a first metal layer, and the first metal layer is electrically connected to the first terminals of the batteries;
the second-terminal connection portion includes a second metal layer, and the second metal layer is electrically connected to the second terminals of the batteries;
the connection-terminal connection portion includes a plurality of terminals, and the terminals are electrically connected to the connection terminals of the batteries; and
the first-terminal connection portion and the connection-terminal connection portion are disposed on an identical surface.

2. The assembled-battery structure according to claim 1, wherein:
the connection-terminal connection portion includes a base plate that supports the plurality of terminals;
the base plate includes a plurality of terminal wires; and
each of the terminal wires is electrically connected to at least one of the terminals.

3. The assembled-battery structure according to claim 1, wherein:
the plurality of terminals is divided for each of the batteries; and
corresponding terminals of terminal groups are connected to one of the terminal wires in parallel, each of the terminal groups being a group of the divided terminals.

4. The assembled-battery structure according to claim 1, wherein the first-terminal connection portion and the connection-terminal connection portion are integrated.

5. The assembled-battery structure according to claim 1, wherein the first-terminal connection portion, the second-terminal connection portion, and the connection-terminal connection portion have flexibility.

6. A composite assembled-battery structure comprising:
a plurality of the assembled-battery structures according to claim 1; and
a joining member that joins the plurality of the assembled-battery structures,
wherein the joining member includes a plurality of joining terminals, and the joining terminals are electrically connected to terminal wires of the assembled-battery structures.
